(19) United States
(12) Patent Application Publication
(10) Pub. No.: US 2017/0263084 A1
(43) Pub. Date: Sep. 14, 2017

(54) Tool Locating System

(71) Applicant: Adam Millius, Newark, DE (US)

(72) Inventor: Adam Millius, Newark, DE (US)

(21) Appl. No.: 15/456,410

(22) Filed: Mar. 10, 2017

Related U.S. Application Data
(60) Provisional application No. 62/306,505, filed on Mar. 10, 2016.

(51) Int. Cl. G08B 5/36; B25H 3/00; B25H 3/02

(52) U.S. Cl. CPC G08B 5/36; B25H 3/028; B25H 3/022; B25H 3/003

(57) ABSTRACT

A tool locating system for locating a tool is provided. The tool locating system comprises a tool storage device with at least one tool recess formed in the tool storage device. The at least one tool recess sized and shaped for receiving the tool. A transmitting component is mounted within the tool storage device. At least one receiving component is embedded in the at least one tool recess with the at least one receiving component communicating with the transmitting component. An illuminable light is positioned immediately adjacent the at least one tool recess. Upon inputting a desired tool request into the transmitting component, the receiving component associated with the desired tool illuminates the light adjacent the at least one tool recess housing the desired tool.

### CLAIM OF PRIORITY

This patent application claims priority under 35 USC 119 (e) (1) from U.S. Provisional Patent Application Ser. No. 62/306,505 filed Mar. 10, 2016, of common inventorship herewith entitled, “Tool Talk,” which is incorporated herein by reference as though the same were set forth in its entirety.

### FIELD OF THE INVENTION

The present invention pertains to the field of tool locating systems, and more specifically to the field of tool locating systems for locating tools and other items by voice command with speech recognition technology coupled with light indicators

### BACKGROUND OF THE INVENTION

The vast majority of home improvement or repair jobs require proper tools in order to be completed successfully. Many people have a fully stocked tool box or chest in their garage, shed or utility closet. Whether one needs to use pliers to loosen a stubborn screw, a hammer to secure woodwork, a wrench to access a leaky pipe or a screwdriver to assemble an entertainment center, it is essential that the appropriate hand tool is always at the ready whenever a task presents itself.

Although collecting an extensive sampling of every hand tool results in one always being prepared, there are drawbacks to such an undertaking. Particularly, all the various sized pliers, wrenches, screwdrivers and wire cutters, along with tiny drill bits and screw tips, quickly become lost or misplaced when removed from the tool box. Whether they have slipped between chair cushions or been absently placed in another room, furiously searching for these items is extremely aggravating and time consuming and can turn a potentially satisfying repair job into a daunting and frustrating chore. Additionally, when someone is working as daylight is waning, it is extremely difficult to see small tools, leading to wasted time guessing if one is picking up the correct implement.

The prior art has put forth several designs for locating items by voice command, Among these are:

U.S. Pat. No. 6,813,341 to Jerome R. Mahoney describes an item location system which relies upon voice activation and responsiveness to identify location of an item sought by a user. The system includes a continuous speech recognition digital signal processor, a programmable microprocessor interfaced therewith, voice input and user feedback mechanisms, including audio or video feedback. Preferred embodiments utilize audio feedback to the user. The continuous speech recognition engine utilizes Hidden Markov Models to create real time continuous speech recognition and feedback.

U.S. Pat. No. 6,012,029 to Sepideh S. Cirino and Michael A. Hreha describes a voice activated location system comprising a transmitter component and a receiver component coupled to a frequently misplaced item. The transmitter receives an audible sound, generates an analog signal corresponding to the audible sound and transmits a coded radio frequency or RF carrier signal upon recognizing that the audible sound represents a voice command. The carrier receives the coded RF carrier signal, decodes the coded RF carrier signal to produce a serial bit stream. The serial bit stream is compared with a digital code associated with the receiver unit. If there is a match, the receiver unit emits an audible sound for a predetermined time period to assist in locating the item.

US Patent Publication 2005/0256720 to Laura Iorio describes a self contained, battery powered device that produces a visible signal or an audible sound when activated. The device includes an electronic microphone, a voice recognition program and a controller circuit for activating the audio or visual signals in response to the appropriate voice signal of the user. The device is attached to an item to be located. During a search for the item attached to the signaling device, the user sends the appropriate voice signal which is recognized by the signaling device which responds by generating the audio or visual signals, allowing the sought after item to be found by the user.

None of these prior art references describe the present invention.

### SUMMARY OF THE INVENTION

It is an object of the present invention to provide a tool locating system consisting of a line of tool kits outfitted with speech recognition technology coupled with Light Emitting Diode or LED light indicators. The tool kit includes an audible language feature and is suitable for use by persons with special needs, such as visually impaired persons and special education students.

The present invention includes tool locating system for locating a tool. The tool locating system comprises a tool storage device with at least one tool recess formed in the tool storage device. The at least one tool recess sized and shaped for receiving the tool. A transmitting component is mounted within the tool storage device. At least one receiving component is embedded in the at least one tool recess with the at least one receiving component communicating with the transmitting component. An illuminable light is positioned immediately adjacent the at least one tool recess. Upon inputting a desired tool request into the transmitting component, the receiving component associated with the desired tool illuminates the light adjacent the at least one tool recess housing the desired tool.

In addition, the present invention is a method for locating a tool. The method comprises providing a tool storage device, forming at least one tool recess in the tool storage device with the tool recess sized and shaped for receiving the tool, mounting a transmitting component within the tool storage device, embedding at least one receiving component in the at least one tool recess, communicating between the at least one receiving component and the transmitting component, positioning an illuminable light immediately adjacent the at least one tool recess, inputting a desired tool request into the transmitting component, associating the receiving component associated with the desired tool, and illuminating the light adjacent the at least one tool recess housing the desired tool.

The present invention further includes a tool locating system for locating a tool. The tool locating system comprises a tool storage device with a plurality of tool recesses formed in the tool storage device. Each tool recess is sized and shaped for receiving a particular tool. A transmitting component is mounted within the tool storage device. An internal microphone and speaker assembly are mounted to the tool storage device and interface with the transmitting component. The microphone allows vocal interface with the transmitting component. A plurality of receiving components with a single receiving component embedded in a single tool recess and the receiving components communicating with the transmitting component. An illuminable light is positioned immediately adjacent each tool recess. Upon inputting a desired tool request into the microphone, interfacing with the transmitting component, the receiving component associated with the desired tool illuminates the light. adjacent the tool recess housing the desired tool.

### BRIEF DESCRIPTION OF THE DRAWINGS

FIG. 1 is a perspective view illustrating a tool locating system, constructed in accordance with the present invention, situated in a large tool storage device with a microphone that receives and recognizes voice commands and drawers that eject as a user requests a specific tool.

FIG. 2 is a perspective view illustrating an ejected drawer of the tool locating system, constructed in accordance with the present invention, showing a requested tool illuminated by an LED light.

FIG. 3 is a perspective view illustrating the tool locating system, constructed in accordance with the present invention, situated in a small tool kit device having opposite sides with tools and showing a microphone for recognizing voice command for a specific tool and counter sunk LED lights for illuminating a requested tool.

FIG. 4 is a sectional side view illustrating a counter sunk LED light of the tool locating system, constructed in accordance with the present invention.

### DETAILED DESCRIPTION OF THE INVENTION

The present invention, hereinafter referred to as a Tool Locating System, indicated generally at 10, is a line of tool kits and storage devices 12 outfitted with speech recognition technology coupled with Light Emitting Diode or LED light indicators. The Tool Locating System 10 enables users to locate misplaced and hard to see tools 14 within tool kits and storage devices 12 with a simple voice command.

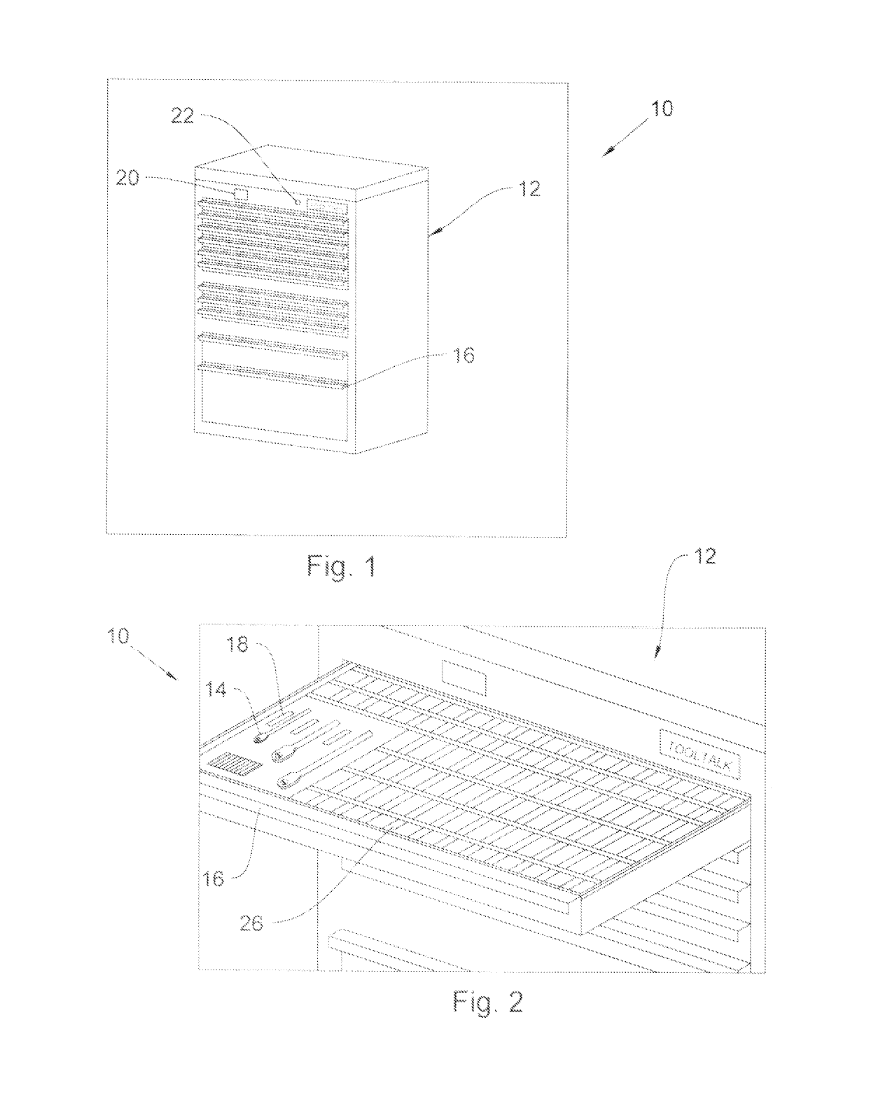

The Tool Locating System 10 of the present invention includes a tool storage device 12. In a first embodiment, as best illustrated in FIGS. 1 and 2, the tool storage device 12 is a large tool storage device having multiple drawers 16. Each of the multiple drawers 16 includes at least one tool recess 18 or niche formed in a top surface of the drawer 16 or an insert positioned within the drawer 16. Each tool recess 18 is sized and shaped to receive a tool 14 or implement. Preferably, each tool recess 18 receives a single tool 14 or implement, however, it is within the scope of the present invention for each tool recess 18 to include multiple tools 14 or implements, especially multiple tools 14 or implement that are typically used together and/or for the same job, at the same time.

In addition, the Tool Locating System 10 of the present invention includes a transmitting component 20 mounted within the tool storage device 12. Preferably, the transmitting component 20 comprises a frequency generator, amplifier, internal and external antenna and required electrical and electronic components and circuitry encased within a durable plastic housing, all mounted within the tool storage device 12. An internal microphone and speaker assembly 22 is mounted to the tool storage device 12 providing interfacing with the transmitting component 20 allowing the user to vocally interface with the transmitting component 20 wherein a command spoken into the microphone 11 and thus, the transmitting component 20, is sent to at least one corresponding receiving component 24. Each corresponding receiver 24 is embedded in a corresponding tool recess 18 formed in the tool storage device 12.

The tool locating system 10 of the present invention additionally includes a light emitting diode or LED light 26 located on the exterior of each tool recess 18, immediately adjacent each tool recess 18, to provide a visual beacon for locating a specific tool 14 within the specific tool recess 18. Preferably, each LED light 26 is counter-sunk in the top surface of the drawer 16 or the insert positioned in the drawer 16 such that the LED light 26 is completely below the top surface of the drawer 16 or completely below a top side of the insert positioned in the drawer 16, as best illustrated in FIG. 4.

Furthermore, in the first embodiment, the Tool Locating System 10 of the present invention includes a mechanism for automatically opening a specific drawer 16 upon receipt of a voice command from the user. While any type of opening mechanism is within the scope of the present invention, the opening of the drawer 16 can be accomplished by a spring biasing the drawer 16 toward an open position with a releasable latch maintaining the drawer 16 in a closed position. Releasing of the releasable latch allows the bias of the spring to open the drawer 16 for access by the user. With the large tool storage device 12 with multiple drawers 16, the specific drawer 16 containing a requested tool 14 opens automatically upon a voice command and the LED indicator 26 illuminates to identify the requested tool 14.

The LED lights 26 of the Tool Locating System 10 of the present invention assists visually impaired individuals in their tool selection. The Tool Locating System 10 has an audible language feature suitable for use by persons with special needs, such as visually impaired persons and special education students.

A preferred embodiment of the Tool Locating System 10 of the present invention is presented as a system integrally incorporated in a complete tool kit produced in various sizes and stocked with essential items from portable wrench and driver sets to all-encompassing tools 14 in rolling drawers 16. Power to the Tool Locating System 10 is corded by electricity or a rechargeable battery source.

Whenever a tool 14 is needed, a user simply speaks into the microphone 22 and transmitting component of the Tool Locating System 10 of the present invention to request a specific tool and activate the receiving component 24. The companion LED light 26 adjacent the tool recess 18 holding the desired tool 14 then emits a continuous light which is easily seen and remains lit until the tool 14 is put back into the tool recess 18 after use. As previously mentioned in the case of larger tool storage systems 12 containing multiple drawers 16, each drawer 16 is configured to automatically open when a user requests a tool 14 in that specific drawer 16 and an LED light 26 illuminates adjacent the tool recess 18 in which the exact tool 14 requested by the user resides.

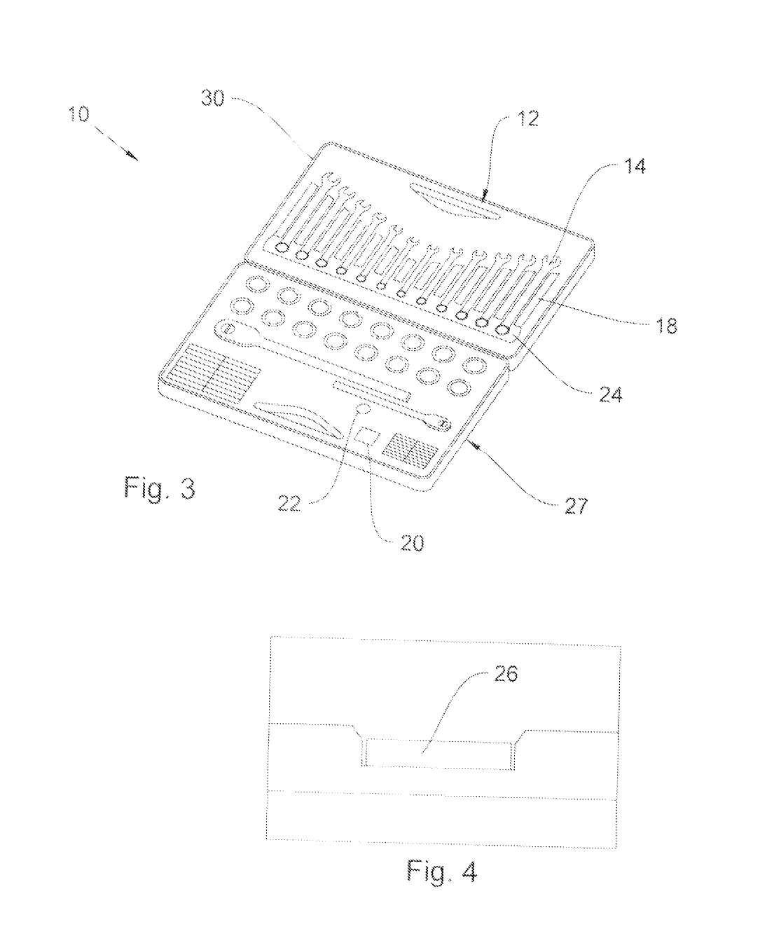

In second embodiment of the Tool Locating System 10 of the present invention, as best illustrated in FIG. 3, the tool storage device 12 includes a hand-held carrying case 27 having a base section 28 and a top section 30 hingedly secured to the base section 26. The hand-held carrying case 27 can include a plurality of tool recesses 18 formed in the base section 28 and/or the top section 30. Like the first embodiment, an LED light 26 is located on the exterior of each tool recess 18, immediately adjacent each tool recess 18. Preferably, each LED light 26 is counter-sunk in the top surface of the base section 28 and/or the top section 30 such that the LED light 26 is completely below a top side of the base section 28 and/or top section 30, as best illustrated in FIG. 4.

The Tool Locating System 10 of the present invention effectively assists handy persons in quickly locating tools 14 that are essential to daily routine projects or to a particular task at hand. Eliminating the need to search through every tool 14 or tool bit in order to find the right one, the Tool Locating System 10 pinpoints the location of a specific item in a matter of seconds through a simple voice command by a user. As a result, time is saved as precious minutes are ticking.

The Tool Locating System 10 of the present invention is very easy to operate. Simply request a tool 14 by the name of the tool 14 such as flat head screwdriver, Allen wrench, one sixteenth bit or three quarters socket. Saying the name into the microphone 22 of the small two sided tool kit 27 results in the bright and clear LED tight 26 indicator illuminating the voice requested tool 14. Saying the specific name into the microphone 22 of the large tool storage box 12 results in a drawer opening 22 and a bright LED indicator light 22 illuminating adjacent the tool recess 18 housing the voice requested tool 14. The simplicity of using the Tool Locating System 10 makes it effectively functional for use by novices as well as skilled tradesmen. Durably constructed with high quality materials, the Tool Locating System 10 will provide many years of continued use by home do it yourselfers, handy men and skilled professional tradesmen.

Although this invention has been described with respect to specific embodiments it is not intended to be limited thereto and various modifications which will become apparent to the person of ordinary skill in the art are intended to fall within the spirit and scope of the invention as described herein taken in conjunction with the accompanying drawings and the appended claims.

1. A tool locating system for locating a tool, the tool locating system comprising:
a tool storage device;
at least one tool recess formed in the tool storage device, the at least one tool recess sized and shaped for receiving the tool;
a transmitting component mounted within the tool storage device;
at least one receiving component embedded in the at least one tool recess, the at least one receiving component communicating with the transmitting component; and
an illuminable light positioned immediately adjacent the at least one tool recess;
wherein upon inputting a desired tool request into the transmitting component, the receiving component associated with the desired tool illuminates the light adjacent the at least one tool recess housing the desired tool.

2. The tool locating system of claim 1 and further comprising:
a plurality of tool recesses formed in the tool storage device;
a plurality of receiving components, a single receiving component associated with each tool recess; and
a plurality of lights, a single light immediately adjacent each tool recess.

3. The tool locating system of claim 1 wherein the tool storage device has a plurality of drawers, each of the drawers having at least one tool recess formed in a top surface of the drawer or an insert positioned within the drawer, each tool recess being sized and shaped to receive a tool.

4. The tool locating system of claim 3 and further comprising:
an opening mechanism for automatically opening a specific drawer upon receipt of a voice command.

5. The tool locating system of claim 4 wherein the opening mechanism is a spring biasing the drawer toward an open position and a releasable latch maintaining the drawer in a closed position, wherein releasing of the releasable latch allows the bias of the spring to open the drawer for access.

6. The tool locating system of claim 1 wherein each tool recess receives a single tool.

7. The tool locating system of claim 1 wherein the transmitting component has a frequency generator, amplifier, internal and external antenna and required electrical and electronic components and circuitry encased within a durable plastic housing, all mounted within the tool storage device.

8. The tool locating system of claim 1 and further comprising:
an internal microphone and speaker assembly mounted to the tool storage device providing interfacing with the transmitting component;
wherein the microphone allows vocal interface with the transmitting component; and
wherein a command spoken into the microphone and thus, the transmitting component, is sent to the at least one corresponding receiving component.

9. The tool locating system of claim 1 wherein the light is an LED light.

10. The tool locating system of claim 1 wherein the light is counter-sunk in the top surface of the drawer or the insert positioned in the drawer such that the light is completely below the top surface of the drawer or completely below a top side of the insert.

11. The tool locating system of claim 1 and further comprising:
an audible language feature for use by persons with special needs.

12. The tool locating system of claim 1 wherein the light remains illuminated until the tool returns to the at least one tool recess.

13. The tool locating system of claim 1 wherein the tool storage device is a hand-held carrying case having a base section and a top section hingedly secured to the base section.

14. The tool locating system of claim 13 wherein the hand-held carrying case has a plurality of tool recesses formed in the base section and the top section.

15. A method for locating a tool, the method comprising:
providing a tool storage device;
forming at least one tool recess in the tool storage device, the tool recess sized and shaped for receiving the tool;
mounting a transmitting component within the tool storage device;
embedding at least one receiving component in the at least one tool recess;
communicating between the at least one receiving component and the transmitting component;
positioning an illuminable light immediately adjacent the at least one tool recess;
inputting a desired tool request into the transmitting component,
associating the receiving component associated with the desired tool; and
illuminating the light adjacent the at least one tool recess housing the desired tool.

16. A tool locating system for locating a tool, the tool locating system comprising:
a tool storage device;
a plurality of tool recesses formed in the tool storage device, each tool recess sized and shaped for receiving a particular tool;
a transmitting component mounted within the tool storage device;
an internal microphone and speaker assembly mounted to the tool storage device and interfacing with the transmitting component, the microphone allowing vocal interface with the transmitting component;
a plurality of receiving components, a single receiving component embedded in a single tool recess, the receiving components communicating with the transmitting component; and
an illuminable light positioned immediately adjacent each tool recess;
wherein upon inputting a desired tool request into the microphone, interfacing with the transmitting component, the receiving component associated with the desired tool illuminates the light adjacent the tool recess housing the desired tool.

17. The tool locating system of claim 16 wherein the tool storage device has a plurality of drawers, each of the drawers having at least one tool recess formed in a top surface of the drawer or an insert positioned within the drawer, each tool recess being sized and shaped to receive a tool, and further comprising;
an opening mechanism for automatically opening a specific drawer upon receipt of a voice command.

17. The tool locating system of claim 16 wherein the light is counter-sunk in the top surface of the drawer or the insert positioned in the drawer such that the light is completely below the top surface of the drawer or completely below a top side of the insert.

18. The tool locating system of claim 16 wherein each tool recess receives a single tool.

19. The tool locating system of claim 16 wherein the light remains illuminated until the tool returns to the at least one tool recess.

20. The tool locating system of claim 16 wherein the tool storage device is a hand-held carrying case having a base section and a top section hingedly secured to the base section, and wherein the hand-held carrying case has a plurality of tool recesses formed in the base section and the top section.
